(19) United States
(12) Patent Application Publication
(10) Pub. No.: US 2009/0181639 A1
(43) Pub. Date: Jul. 16, 2009

(54) System, method and device for delivering notifications via a communications network

(76) Inventor: Richard H. Glanton, Chicago, IL (US)

Correspondence Address: GIBBONS P.C., ONE GATEWAY CENTER, NEWARK, NJ, 07102, US

(21) Appl. No.: 12/008,692

(22) Filed: Jan. 11, 2008

(51) Int. Cl. H04M 11/04

(52) U.S. Cl. 455/404.1

(57) ABSTRACT

A cellular communications device having operational characteristics set by a device user, the device including device executable code for: detecting at least one communication indicative of at least one broadcast emergency alert system-type signal; and effecting a predetermined user perceptible response by the cellular device responsively to the detecting; wherein, the predetermined user perceptible response is exclusively indicative of emergency alert system-type notifications being broadcast independent of the operational characteristics set by the user.

### FIELD OF THE INVENTION

The present invention relates generally to communications systems and methods, and more particularly to systems, methods and devices for delivering notifications, such as emergency notifications, via a communications network, such as a wireless communications network.

### BACKGROUND OF THE INVENTION

“This is a test of the Emergency Alert System—this is only a test . . . ” may occasionally be heard on local broadcast stations, satellite radios, Direct Broadcast Satellites (DBS) and cable systems in the United States. The Emergency Alert System (EAS) superseded the Emergency Broadcast System (EBS) in the United States.

The EAS is implemented through a cooperative arrangement among the Federal Communications Commission (FCC), the Federal Emergency Management Agency (FEMA), now part of the Department of Homeland Security, the National Weather Service (NWS), and the states. The FCC provides information to broadcasters, cable system operators, and other EAS participants regarding the technical and operational requirements of the EAS. Additionally, the FCC ensures that state and local EAS plans conform to EAS requirements. FEMA provides direction and assistance for state and local emergency management officials to develop, implement, and maintain their EAS structure. The NWS provides emergency weather information to alert the public of dangerous local weather conditions and other emergencies. State and local plans for the activation of the EAS are created by the State Emergency Communications Committees (SECCs) and Local Emergency Communications Committees (LECCs), which are formed by government officials and representatives from the broadcast and cable industries.

The EAS allows broadcasters to receive and send emergency information quickly and automatically, even if their facilities are unattended. EAS equipment also provides a method for automatic interruption of regular programming. Additional mechanisms for disseminating notifications, such as EAS notifications, is desirable.

However, the EAS fails to serve any population outside that in the immediate area of the emergency. Further, the EAS has not yet been extended to other communications media, such as cellular telephones, personal digital assistants, laptops, other mobile communication devices, and the like. Finally, the EAS does not provide, or provide for, subscription-based services that allow for uniform notification of emergencies to those effected by factors other than the immediate geographic locus of the emergency. Without uniform notification in such extensions beyond the current EAS, or beyond the EAS altogether to subscription-based systems, it is unlikely that recipients of an emergency message will understand the message, take the desired action in accordance with the message, or even pay attention to the message.

Thus, a need exists for a system, method and device capable of delivering uniform emergency notifications for subscription and/or non-subscription based emergency services.

### SUMMARY OF THE INVENTION

A method and system for disseminating information indicative of an emergency alert system-type notification using a cellular communications system having a plurality of cellular communication areas, including: a plurality of cellular communications devices being operable with the cellular communications system; receiving, by the cellular communications system, at least one broadcast emergency alert system-type signal, which may include information indicative of an affected characteristic, such as a particular geographic area; identifying at least one of the cellular communication areas or devices corresponding to the affected characteristic indicated by the received emergency alert system-type signal; and, transmitting, by the cellular communications system, at least one cellular notification to ones of the cellular communication devices corresponded to the affected characteristic; wherein: each of the provided cellular communication devices has a substantially same predetermined user perceptible response to receiving the at least one cellular notification, and the predetermined user perceptible response of each of the provided cellular communications devices is substantially the same as that of another plurality of cellular communications devices being operable with at least one other cellular communications system. The predetermined user perceptible response may be exclusively indicative of an emergency alert.

The at least one broadcast emergency alert system-type signal may further include information indicative of an affected characteristic of an event type. The cellular notification may thus include information indicative of the event type indicated by the received emergency alert system-type signal. The predetermined user perceptible response of each of the provided plurality of cellular communication devices comprises presenting information indicative of the event type information included in the cellular notification.

The predetermined user perceptible response may be independent of at least two of: manufacturer, model, cellular communications system and user set options. The predetermined user perceptible response is independent of manufacturer, model, cellular communications system and user set options. The predetermined user perceptible response may include a predetermined audible alert. The audible alert may include a pulsed tone. The predetermined user perceptible response may include a predetermined pulsed vibration. The predetermined user perceptible response may include a predetermined visual indicator.

The cellular communications devices may be adapted to have the predetermined user perceptible response independent of user set options. A cellular communications device having operational characteristics set by a device user, the device including device executable code for: detecting at least one communication indicative of at least one broadcast emergency alert system-type signal; and effecting a predetermined user perceptible response by the cellular device responsively to the detecting; wherein, the predetermined user perceptible response is exclusively indicative of emergency alert system-type notifications being broadcast independent of the operational characteristics set by the user.

Thus, the present invention provides a system, method and device capable of delivering uniform emergency notifications for subscription and/or non-subscription based emergency services.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and:

FIG. 1 illustrates a graphical representation of an EAS-type message;

FIG. 2 illustrates a graphical representation of a communications system having communications devices located in a plurality of communication areas corresponding to a plurality of geographic areas;

FIG. 3 illustrates a graphical representation of a system according to an embodiment of the present invention;

FIG. 4 illustrates a graphical representation of a system suitable for use with the system of FIG. 3 and according to an embodiment of the present invention;

FIG. 5 illustrates a flow diagram of a process according to an embodiment of the present invention; and

FIG. 6 illustrates a first plurality of communications devices being operable with a first communications system and a second plurality of communications devices being operable with a second communications system.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical communications systems and devices. However, because such elements are well known in the art, and because they do not facilitate a better understanding of the present invention, a discussion of such elements is not provided herein. The disclosure herein is directed to all such variations and modifications known to those skilled in the art.

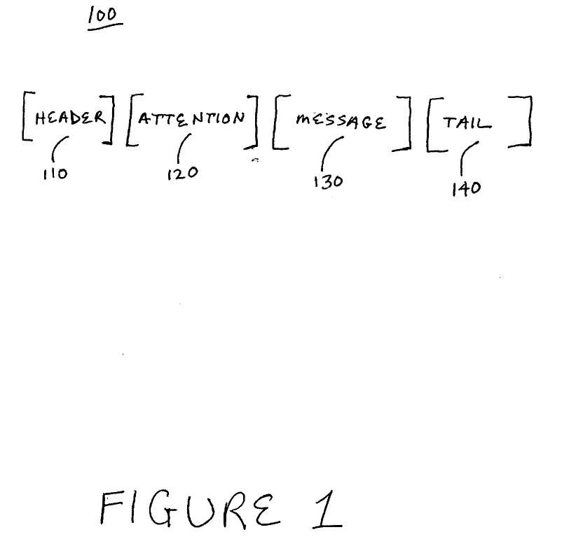

By way of non-limiting example only, and referring now to FIG. 1, there is shown a graphical representation of an EAS-type message 100 that may be utilized in certain embodiments of the present invention. An EAS compliant message is a non-limiting example of an EAS-type message. For example, an EAS-type message, as used herein, refers to any message directed to those devices having an “affected characteristic.” An affected characteristic, although discussed herein principally with respect to a geographic characteristic, includes, by way of non-limiting example: being within range of an EAS message; being in a particular geographic region; suffering from a particular condition; having interest in a certain occurrence; having interest in a certain geographic area from which one is remote; or having interest in a certain entity. As such, in a preferred embodiment, an EAS-type message with regard to an affected characteristic may constitute a message regarding an emergency, but it almost goes without saying that the present invention additionally contemplates non-emergency messages generating a uniform response in a receiving device. Thus, EAS-type messages may be sent in accordance with an EAS alert, or may be sent based on subscription by the user to the system and method of the present invention.

In the exemplary embodiment of FIG. 1 directed to a geography-based affected characteristic, illustrated message 100 includes four parts: a digitally encoded (e.g., Specific Area Message Encoding (SAME)) header 110, an attention signal 120, a message 130 (such as an audio announcement), and a digitally encoded end-of-message marker or tail 140.

In certain embodiments of the invention, header 110 may include a receiver calibration preamble having a pre-defined data sequence. Header 110 may include data indicative of the message originator (e.g., a civil authority or weather service). Header 110 may include data indicative of the type of event to which message 100 relates (e.g., a hazardous waste warning, evacuation order or law enforcement warning). Header 110 may include data indicative of an affected geographic area and temporal duration (e.g., county, state, part of county codes and a terminating date and/or time). Header 110 may include additional information, such a broadcaster identification, for example.

In certain embodiments of the present invention, attention signal 120 may take the form of an audible tone (e.g., combined 853 and 960 Hz tones). Attention signal 120 may be selectively included if a message 130 is also included. End-of-message marker or tail 140 may include a preamble and predefined data sequence, for example.

In addition to audible alerts, data for visual alerts, such as text crawls across a displayed television signal may be provided. While a particular EAS-type signal has been discussed, other types of alert signals having analogous information may alternatively be used.

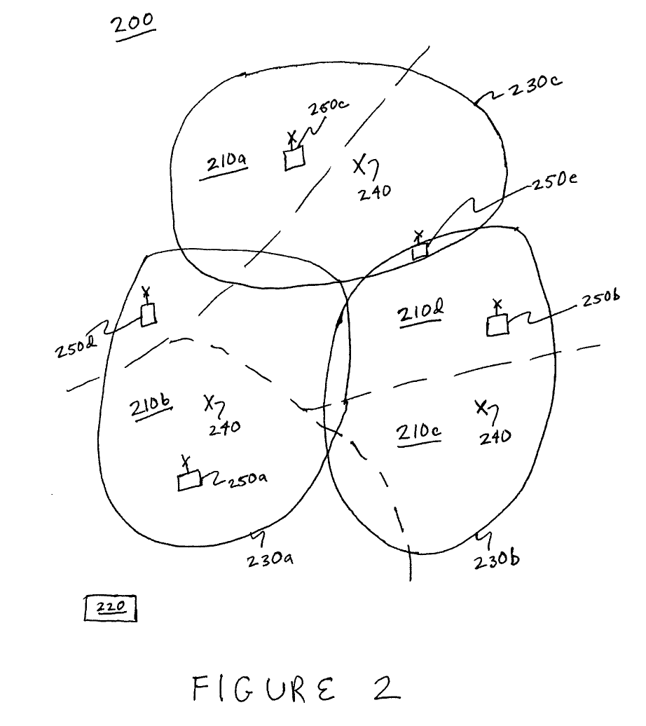

Referring now to FIG. 2, there is shown a depiction of an exemplary geographic area 200. Area 200 includes a plurality of geographic sub-areas 210_{a-d}. A communications system 220 services at least a portion of at least one of the sub-areas 210_{a-d}. In the illustrated case, system 220 services service areas 230_{a-c} via antennae 240. Communications system also includes communications devices 250ₐ₋ₑ. Devices 250ₐ₋ₑ receive/transmit signals from/to antennae 240.

As can be seen in FIG. 2, there is a correspondence between ones of geographic sub-areas 210_{a-d} and service areas 230_{a-c}. Where the service areas are fixed, the correspondences are fixed. Where the service areas are variable (e.g., one or more of antennae 240 are mobile), the correspondences are variable. Table-1 illustrates exemplary ones of such correspondences.

TABLE 1

| Geographic Area | Service Area(s) |
|---|---|
| 210a | 230a, 230c |
| 210b | 230a, 230b |
| 210c | 230a, 230b |
| 210d | 230a, 230b, 230c |

There is also a correspondence between ones of service areas 230_{a-c} and devices 250ₐ₋ₑ. Where the service areas and devices are fixed, the correspondences are fixed. Where the service areas or devices are variable (e.g., one or more of antennae 240 and/or devices 250ₐ₋ₑ are portable), the correspondences are variable. Table-2 illustrates exemplary ones of such correspondences.

TABLE 2

| Service Area | Device(s) |
|---|---|
| 230a | 250a, 250d |
| 230b | 250b, 250e |
| 230c | 250c, 250e |

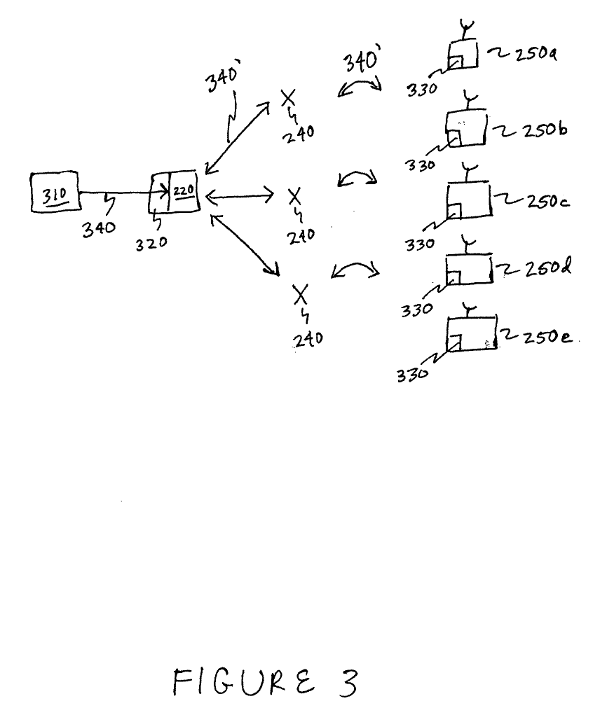

Referring now to FIG. 3, there is shown a depiction of a system 300 according to an embodiment of the present invention. System 300 includes an alert transmitter 310, an alert transceiver 320 incorporated with communications system 220 and an alert receiver 330 incorporated in at least some of devices 250ₐ₋ₑ.

In certain embodiments of the present invention, alert transmitter 310 may take the form of a conventional EAS signal transmitter. In certain embodiments of the present invention, transmitter 310 may take the form of a transceiver 320, where transmitter 310 retransmits a received EAS-type signal. Of course, other types of signal generators and transmitters may be utilized to transmit information analogous to at least some of that discussed with regard to message 100 herein-above. Regardless of the particulars, alert transmitter 310 transmits at least one alert signal 340 to alert transceiver 320. In certain embodiments of the present invention, alert signal 340 may include one or more messages 100.

In certain embodiments of the present invention, communications system 220/antennae 240 are part of a wireless communications system, such as a cellular communication and/or digital data network. Non-limiting examples include digital cellular networks, such as code division multiple access (CDMA) based networks, and Global System for Mobile Communications (GSM) based networks. In certain embodiments of the present invention, transceiver 320 may be incorporated into a base station or other switching device or center. Transceiver 320 and/or receiver 330 may take the form of hardware, software, firmware, or a combination thereof.

Regardless of the particulars, transceiver 320 receives at least one alert signal 340, and transmits at least one cellular notification or alert signal 340′ to at least one of the devices 250ₐ₋ₑ via at least one of antennae 240. The at least one device 250ₐ₋ₑ receives signal 340′, and alerts a user responsively thereto.

In certain embodiments of the present invention, transceiver 320 may incorporate a computing device 405. A “computing device”, as referred to herein, typically includes a processor 410, associated memory registers, program controls, and input/output circuitry. A processor typically includes a Central Processing Unit (CPU) 415. A CPU generally includes an arithmetic logic unit (ALU), which performs arithmetic and logical operations, and a control unit, which extracts instructions (e.g., code) from memory (e.g., 420) and decodes and executes them, calling on the ALU when necessary. “Memory”, as used herein, refers to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including a processor. Memory preferably stores a computer program, e.g., code or sequence of instructions being operable by a processor.

By way of further, non-limiting example, computing device 405 also includes one or more file storage mediums (other memory) 425 internal or external to computer 405 for storing data and processor executable code. Computer 405 also includes interface(s) 430 connecting computer 405 to external accessories/devices, such as a display, keyboard, pointing device, printer and/or other computing or communications devices. In certain embodiments of the present invention, memory 420 and/or storage medium 425 may store data indicative of correspondences between geographic sub-areas 210_{a-d} and service areas 230_{a-c} (Table-1) and/or between ones of service areas 230_{a-c} and devices 250ₐ₋ₑ (Table-2). Memory 420 and/or storage medium 425 may also include data indicative of descriptions for message 100 (FIG. 1) event-type indicative data or codes.

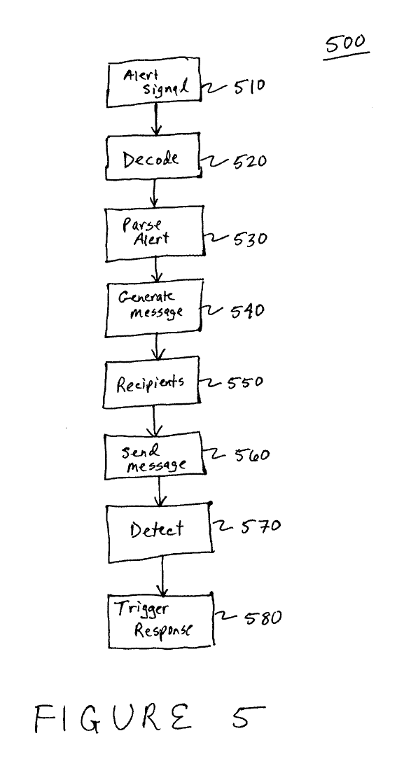

CPU 410 both controls, and is controlled by, other hardware, as well as software stored in a portion of memory 420 and on a portion of storage medium 425. For example, storage medium 425 may take the form of a hard disk drive being internal to computer 405. Processor-executable code being stored in medium 425 and/or memory 420 may embody methods of the present invention, such that execution thereof causes computer 405 to carry-out a portion of the process described in connection with and depicted in FIG. 5, for example. Processor-executable code may also be stored in a memory within a cellular communication device 250ₐ₋ₑ, such that execution thereof by processor associated with a cellular communication device 250ₐ₋ₑ carries out a portion of the process described in connection with and depicted in FIG. 5, for example.

In certain embodiments of the present invention, interface(s) 430 may be coupled to a receiver/decoder 450 being suitable for receiving and decoding transmitter alert signals 340. EAS alert signal receivers and decoders, such as those being commercially available from TFT, Inc. of San Jose, Calif., are generally known. Alternatively, such an EAS-type alert signal, detecting, receiving and decoding functionality may be incorporated into computing device 405 and the base station or other switching device or center equipment. Either way, the system 220 serves to detect, receive and decode EAS-type signals.

Referring now to FIG. 5, there is shown a block diagram of a method 500 according to an embodiment of the present invention. Process 500 commences with detecting an alert signal 340 at block 510. It almost goes without saying, in light of the discussion herein, that the alert signal detected at block 510 may be generated in any of a number of ways. For example, the alert signal may be an EAS alert. Alternatively, the alert signal may be provided from a subscription service, wherein the subscription service response manager may be provided with a graphical user interface from which the response manager can select, from a map, drop-down menus, or the like, an affected characteristic necessitating the sending of an alert. Alternatively, all alerts, including EAS alerts, may pass through such a subscription service, or a non-subscription service.

The detected signal may be decoded at block 520. Where the received signal 340 includes an EAS-type message 100 (FIG. 1), decoding at block 520 may recover at least one of message header 110, signal 120, message 130 and tail 140.

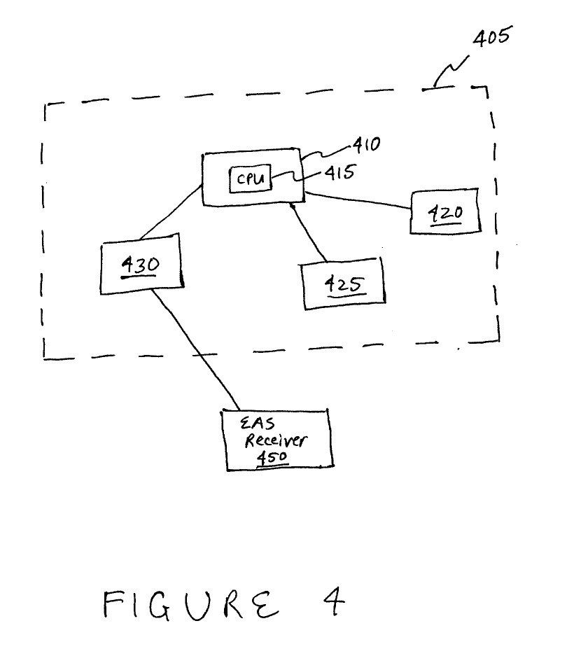

The recovered alert information may be parsed at block 530. Parsing at block 530 may be accomplished with computing device 405 (FIG. 4), once at least a portion of the decoded alert information is passed via interface 430 from receiver/decoder 450 or is otherwise available to computing device 405, for example. Parsing 530 may be performed at an emergency response center, wherein all or only devices 250ₐ₋ₑ having affected characteristic(s) are selected to be targeted with the message at block 540 (e.g. certain devices are to have the message “pushed” to them in a targeted manner); at a base station, wherein an emergency response center sends the alert to all base stations and the base station generates the message at block 540 to all devices 250ₐ₋ₑ or to only certain devices 250ₐ₋ₑ after having discerned that only those certain devices have the affected characteristic; or at the device 250ₐ₋ₑ which, in such an embodiment, may be or include computing device 405. Parsing at block 530 may include parsing out message-included data indicative of the type of event to which message 100 relates (e.g., a hazardous waste warning, evacuation order or law enforcement warning, warning to all those suffering from lung-disorders regarding an air-borne pathogen) and an affected characteristic, such as a geographic area (e.g., county, state, part of county codes), persons suffering from a particular health issue (e.g., lung or heart problems), or an issue about which a person associated with the mobile device has asked to be notified via a subscription (e.g. a coup in a foreign country, a nuclear explosion geographically remote from that person). Information parsed from message 100 may be stored in memory 420 and/or storage 425, for example.

At least a portion of the information parsed out at block 530 may be used to generate message 340′ at block 540. Message generating at block 540 may be accomplished with computing device 405. For example, message 100 data indicative of the event type parsed out at block 530 may be cross-referenced to memory 420 and/or storage medium 425 data indicative of event-type descriptions, which may likewise be cross-referenced to users of devices 250ₐ₋ₑ having a subscribed affected characteristic matching such event-type descriptions. One or more descriptions identified at block 540 may be used to generate message 340′. By way of further example, where message 130 includes event-type indicative data, and that data is parsed out at block 530, that data may be used to generate message 340′ at block 540.

At least a portion of the information parsed out at block 530 may be used to identify intended recipients for message 340′ at block 550. Intended recipient identification at block 550 may be accomplished with computing device 405. For example, message 100 data indicative of affected geographic area parsed out at block 530 may be cross-referenced to memory 420 and/or storage medium 425 stored data indicative of correspondences between geographic sub-areas 210_{a-d} and service areas 230_{a-c} (e.g., Table-1) at block 550. Accordingly, those service areas 230_{a-c} that correspond to affected areas for an alert may be identified at block 550.

In certain embodiments of the present invention, devices 250ₐ₋ₑ that are in communication with antennae 240 associated with an affected geographic area may have the message generated at block 540 broadcast to them at block 560.

In certain embodiments of the present invention, the identified service areas 230_{a-c} may be used to identify particular devices 250ₐ₋ₑ located within affected areas. For example, service areas 230_{a-c} identified at block 550 may be cross-referenced to memory 420 and/or storage medium 425 stored data indicative of correspondences between service areas 230_{a-c} and devices 250ₐ₋ₑ (e.g., Table-2). Those devices 250ₐ₋ₑ associated with identified service areas may have messages generated at block 540 transmitted to them at block 560.

Referring again to FIG. 3, in certain embodiments of the present invention devices 250ₐ₋ₑ may take the form of cellular communications devices adapted for use with, e.g., operable with system 220, such as telephones, pagers and text messaging devices. Accordingly, devices 250ₐ₋ₑ communicate with system 220 via antennae 240 in a conventional manner.

In certain embodiments of the present invention, receiver 330 monitors system 220 transmissions. For example, receiver 320 may monitor system 330 transmissions for signal(s) 340′. In certain embodiments of the present invention, signals 340′ may transmitted by antennae 240 on a dedicated channel or frequency. Alternatively, signals 340′ may be transmitted to and received by devices 250ₐ₋ₑ in any conventional manner.

Referring again to FIG. 5, regardless of the particulars, when a signal 340′ is received by a device 250ₐ₋ₑ, it may be detected by and processed by receiver 330 at block 570. In certain embodiments of the present invention, message 340′ may include data identifying it as an alert signal 340′ and the message generated at block 540 (FIG. 5). In certain embodiments of the present invention, upon receiving a message 340′, receiver 320 may trigger the device 250ₐ₋ₑ it is incorporated into to be configured in a predetermined condition and/or execute a predetermined sequence of steps associated with alerts 340′ at block 580.

By way of further, non-limiting example, typical cellular communications devices have processors and memory, and execute code to provide different user perceptible responses to trigging criteria (e.g., an incoming call or message), depending upon manufacturer, model, system 220 provider and user set options, for example. For example, typical cellular communications devices have different audible alerts and/or visual appearances, depending upon manufacturer, model, system 220 provider and user set options, for example. Further, typical cellular communications devices have different visual and/or tactile indicators, such as lighting elements and vibration characteristics depending upon manufacturer, model, system 220 provider and user set options, for example.

According to certain embodiments of the present invention, different devices 250ₐ₋ₑ exhibit a same user perceptible response upon receipt of an alert signal 340′, regardless of manufacturer, model, system 220 provider or user set options, for example. By way of non-limiting example, it should be understood that a cellular communication device typically includes a plurality of pre-set or user-set operational characteristics or options. A predetermined user perceptible response may be triggered upon receipt of an alert signal 340′ by different devices 250ₐ₋ₑ regardless of these settings. According to certain embodiments of the present invention, the predetermined user perceptible response may over-ride any or all of these settings. Further, while a cellular communications device may include a functionality that may disable or otherwise inhibit it from providing the predetermined user perceptible response, such a response itself may still be independent of user settings.

According to certain embodiments of the present invention, such a predetermined user perceptible response may be reserved for exclusive use to indicate an alert signal 340′ being received, and hence that an alert signal 340 has been broadcast. Such a predetermined user perceptible response may include sounding a predetermined audible alert (e.g., combined 853 and 960 Hz tones). Such a predetermined user perceptible response may include producing a predetermined visual alert (e.g., a predetermined alert screen, or a flashing light). Such a predetermined user perceptible response may include producing a predetermined tactile alert (e.g., a predetermined vibratory pattern). Such a predetermined user perceptible response may include a combination of audible, visual and tactile responses. By providing a common user experience that is largely if not entirely independent of device settings, dissemination to, reviewing of and understanding of alerts may be improved for persons being within a response user-perceptible range of an adapted communication device.

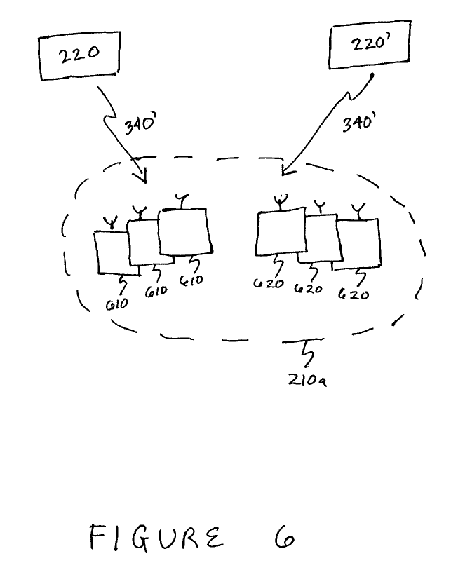

By way of further non-limiting example, in certain embodiments of the present invention, such responses may be predefined regardless of manufacturer, model, system 220 provider or user set options. In other words, and referring now also to FIG. 6, a first plurality of user devices 610 of different manufacturer and model types, communicatively coupled to a first system provider 220 and having different user options set (e.g., silent, don't vibrate and green background on the display) may each respond substantially the same (e.g., within practicable device constraints) to a received signal 340′. Such a response may also be exhibited by a second plurality of user devices 620 of other manufacturer and model types, communicatively coupled to a second system provider 220′. The second devices may have different user options set (e.g., loud ring style, vibrate on and blue background on the display). By way of further non-limiting example, upon receipt of an alert signal 340′ devices 610, 620 may sound pulsed combined 853 and 960 Hz tones at a maximum ring volume, initiate a similarly pulsed vibration at a maximum vibratory power, flash one or more light elements and display “EMERGENCY ALERT SYSTEM” on its device display. Each device 610, 620 may then display, such as via a static text display or a text crawl for example, data indicative of and/or associated with the received alert signal 340′. In certain embodiments of the present invention, the predetermined user perceptible response may be fixed or set as a variable depending upon the type of event.

According to certain embodiments of the present invention, EAS-type signal providers, and/or other interested parties, may publicize the predetermined response, so as to reinforce its importance. For example, EAS communications via local broadcast stations, satellite radios, Direct Broadcast Satellites (DBS) and cable systems in the United States may be supplemented with explanations of the predetermined user preceptible response. Similarly, analogous signal tests may be sent periodically to devices 250ₐ₋ₑ, for example.

According to certain embodiments of the present invention, instructions may be provided with or to supplement EAS-type alerts. For example, a first EAS-type alert may indicate an event code. A second EAS-type alert may supplement the first EAS-type alert, by providing data indicative of a suggested action. The suggested action may have a different affected geographic area, such that different advice is given depending upon location. By way of further non-limiting example, a first EAS-type signal may indicate an impending flood warning to each of regions 210a, 210b and 210c of FIG. 1. In such a case, devices 250a, 250b, 250c, 250d and 250e would receive associated alert signals 340′. Users of these devices would experience the same predetermined user perceptible response and be suitably warned. It may be determined that region 210b needs to be evacuated, but regions 210a and 210c do not. In such a case another EAS-type signal may indicate an evacuation notice, together with data indicative of instructions for refuge. In this case, devices 250a and 250d would receive associated alert signals 340′. Again, users of these devices would experience the same predetermined response (which may be different than the prior response). Upon reviewing the alert, a user of device 250a would be suitably informed, and a user of device 250d could be advised they are not in the affected area (via the data indicative of instructions for refuge, for example).

As discussed above with respect to FIGS. 1-5, the EAS-type alerts of the present invention may be subscription or non-subscription based. For example, EAS alerts preferably do not require any subscription for receipt by the devices 250ₐ₋ₑ of the present invention. However, device 250ₐ₋ₑ user may subscribe to one or more services that provide EAS-type alerts, such as alerts based on particular affected characteristics as discussed throughout. Thus, subscribers may select only particular affected characteristic, instead of or in addition to standard affected characteristics (such as geographic proximity to an EAS message), about which that subscriber wishes to be notified. Nonetheless all such notifications with regard to any affected characteristic cause the same response from any mobile communications device in any network. Subscriptions services as discussed herein may be fee-based, as will be apparent to those skilled in the art, and, upon making a subscription, the user of a device may request that only particular affected characteristics, or categories of affected characteristics, be associated with that device for notification.

It will be apparent to those skilled in the art that modifications and variations may be made without departing from the spirit or scope of the invention.

What is claimed is:

1. A method for disseminating information indicative of an emergency alert system-type notification using a cellular communications system having a plurality of cellular communication areas, comprising:
providing a plurality of cellular communications devices being operable with the cellular communications system;
receiving, by the cellular communications system, at least one broadcast emergency alert system-type signal including information indicative of an affected characteristic;
identifying at least one of the cellular communication devices corresponding to the affected characteristic indicated by the received emergency alert system-type signal; and,
transmitting, by the cellular communications system, at least one cellular notification to ones of the cellular communication devices identified as having the affected characteristic;
wherein:
each of the provided cellular communication devices has a substantially same predetermined user perceptible response to receiving the at least one cellular notification, and
the predetermined user perceptible response of each of the provided cellular communications devices is substantially the same as that of another plurality of cellular communications devices being operable with at least one other cellular communications system.

2. The method of claim 1, wherein the predetermined user perceptible response is exclusively indicative of an emergency alert.

3. The method of claim 1, wherein:
the at least one broadcast emergency alert system-type signal further includes information indicative of an affected characteristic comprising an event type;
the cellular notification includes information indicative of the event type indicated by the received emergency alert system-type signal; and
the predetermined user perceptible response of each of the provided plurality of cellular communication devices comprises presenting information indicative of the event type information included in the cellular notification.

4. The method of claim 1, wherein the predetermined user perceptible response is independent of at least two of: manufacturer, model, cellular communications system and user set options.

5. The method of claim 4, wherein the predetermined user perceptible response is independent of manufacturer, model, cellular communications system and user set options.

6. The method of claim 1, further comprising adapting the cellular communications devices to have the predetermined user perceptible response independent of user set options.

7. The method of claim 1, wherein the predetermined user perceptible response comprises a predetermined audible alert.

8. The method of claim 7, wherein the audible alert comprises a pulsed tone.

9. The method of claim 1, wherein the predetermined user perceptible response comprises a predetermined pulsed vibration.

10. The method of claim 1, wherein the predetermined user perceptible response comprises a predetermined visual indicator.

11. The method of claim 1, wherein the at least one broadcast emergency alert system-type signal further includes information indicative of an affected characteristic comprising a particular geographic area, and wherein said transmitting comprises transmitting, by the cellular communications system, at least one cellular notification to ones of the cellular communication devices in the particular geographic area.

12. A cellular communications device having operational characteristics set by a device user, the device comprising device executable code for:
detecting at least one communication indicative of at least one broadcast emergency alert system-type signal; and
effecting a predetermined user perceptible response by the cellular device responsively to the detecting;
wherein, the predetermined user perceptible response is exclusively indicative of emergency alert system-type notifications being broadcast, independent of the operational characteristics set by the user.

13. The device of claim 12, wherein the predetermined user perceptible response is independent of at least two of: manufacturer, model, cellular communications system and user set options.

14. The device of claim 12, wherein the predetermined user perceptible response is independent of manufacturer, model, cellular communications system and user set options.

15. The device of claim 12, wherein the predetermined user perceptible response comprises a predetermined audible alert.

16. The device of claim 15, wherein the audible alert comprises a pulsed tone.

17. The device of claim 12, wherein the predetermined user perceptible response comprises a predetermined pulsed vibration.

18. The device of claim 12, wherein the predetermined user perceptible response comprises a predetermined visual indicator.

19. A system for disseminating information indicative of an emergency notification over at least two cellular systems each having a plurality of cellular communication areas, comprising:
a plurality of mobile communications devices being operable with at least two of the at least two cellular systems;
a receiver for receiving at least one broadcast emergency alert including information indicative of an affected at least one of the cellular communication areas;
a parser that identifies at least one of the cellular communication devices associated with the at least one affected cellular communication area; and,
a transmitter that transmits, via a current one of the at least two cellular systems in which the identified at least one cellular communication device is resident, a cellular notification in accordance with the at least one broadcast emergency alert for receipt by the identified at least one cellular communication device;
a receiver that receives the cellular notification, and that effectuates an standard response by the at least one cellular communication device to the cellular notification, irrespective of which of the at least one cellular device receives the cellular notification and irrespective of which of the at least two cellular systems is the current one of the at least two cellular systems.

20. The system of claim 19, wherein the association of the at least one cellular device with the at least one cellular communications area comprises a residence of the at least one cellular device within the at least one communications area.
